(19) United States
(12) Patent Application Publication
(10) Pub. No.: US 2015/0379793 A1
(43) Pub. Date: Dec. 31, 2015

(54) COMMUNICATION SYSTEM, IN-VEHICLE DEVICE, MOBILE DEVICE, AND COMMUNICATION METHOD

(71) Applicant: Hiroko MURAKAMI, (US)

(72) Inventor: Hiroko MURAKAMI, Toyota-shi, Aichi-ken (JP)

(73) Assignee: TOYOTA JIDOSHA KABUSHIKI KAISHA, Toyota-shi, Aichi-ken (JP)

(21) Appl. No.: 14/766,857

(22) PCT Filed: Feb. 11, 2014
(86) PCT No.: PCT/IB2014/000135

§ 371 Date: Aug. 10, 2015

(30) Foreign Application Priority Data
Feb. 13, 2013 (JP) 2013-026031

(51) Int. Cl. G07C 9/00; B60R 25/20; B60R 25/25; H04B 7/26

(52) U.S. Cl. CPC G07C 9/00111; H04B 7/26; B60R 25/20; B60R 25/25; B60R 2325/20; B60R 2325/103

(57) ABSTRACT

A communication system includes an in-vehicle device including an in-vehicle device communication unit that performs wireless communication using a short-range wireless communication method, and an in-vehicle device control unit that executes control for transmitting a request signal; a mobile terminal including a mobile terminal communication unit that performs wireless communication using a short-range wireless communication method; and a mobile device including a mobile device communication unit that performs wireless communication using a short-range wireless communication method, a mobile device control unit that executes control for transmitting a response signal to a request signal from the in-vehicle device, and a mobile device transmission unit that transmits a response signal to the in-vehicle device according to the control by the mobile device control unit. The in-vehicle device control unit executes control for transmitting the request signal when the short-range wireless communication network is formed with the mobile terminal and the mobile device.

### BACKGROUND OF THE INVENTION

1. Field of the Invention

This invention relates to a communication system, an in-vehicle device, a mobile device, and a communication method.

2. Description of Related Art

Automobile systems are available which enable doors of a vehicle to be locked or unlocked, or an engine of the vehicle to be started without the use of a mechanical key. These systems are also referred to as smart entry & start systems.

In a smart entry & start system, communication is performed between a mobile device (key) and an electronic control unit (ECU) or a body control module (BCM) mounted on a vehicle. Once communication is established between the mobile device and the ECU or the BCM, doors can be locked or unlocked and the engine can be started.

In addition, keyless entry systems are available in which, for example, signals are directly transmitted from a wireless key to a vehicle when the wireless key is near the vehicle and signals are transmitted to the vehicle via a mobile phone when the wireless key is far away (for example, refer to Japanese Patent Application Publication No. 2005-299119 (JP 2005-299119 A).

In the smart entry & start system described above, the mobile device receives a request signal from an in-vehicle device. The mobile device transmits a response signal to the request signal to the in-vehicle device. The in-vehicle device collates the mobile device based on the response signal. The in-vehicle device controls the vehicle in accordance with a collation result of the mobile device.

In addition, in the smart entry & start system described above, when the mobile device enters an area in which a request signal from the in-vehicle device can be detected and receives the request signal, the mobile device transmits a response to the request signal. In other words, the mobile device passively responds to the request signal. Therefore, when a pseudo signal copied from the request signal transmitted by the in-vehicle device is transmitted, the mobile device may possibly transmit a response to the pseudo signal even when the mobile device is not in a vicinity of the in-vehicle device.

Once a pseudo signal copied from a request signal is created, there is a risk that the pseudo signal may be transmitted by a communication apparatus in the possession of a thief impersonating a user when the user is away from the vehicle. A transmission of a pseudo signal causes a response to the pseudo signal to be transmitted by the user's mobile device and is detrimental to security.

### SUMMARY OF THE INVENTION

The invention improves security in communication between a mobile device and an in-vehicle device.

A communication system according to a first aspect of the invention includes an in-vehicle device including an in-vehicle device short-range wireless communication unit that performs wireless communication using a short-range wireless communication method, and an in-vehicle device control unit that executes control for transmitting a request signal; a mobile terminal including a mobile terminal short-range wireless communication unit that performs wireless communication using a short-range wireless communication method; and a mobile device, including a mobile device short-range wireless communication unit that performs wireless communication using a short-range wireless communication method, a mobile device control unit that executes control for transmitting a response signal to a request signal from the in-vehicle device, and a mobile device transmission unit that transmits a response signal to the in-vehicle device according to the control by the mobile device control unit. The in-vehicle device control unit executes control for transmitting the request signal when the short-range wireless communication network is formed with the mobile terminal and the mobile device by the in-vehicle device short-range wireless communication unit.

A communication system according to a second aspect of the invention includes an in-vehicle device including an in-vehicle device short-range wireless communication unit that performs wireless communication using a short-range wireless communication method, and an in-vehicle device control unit that executes control for transmitting a request signal; a mobile terminal including a mobile terminal short-range wireless communication unit that performs wireless communication using a short-range wireless communication method; and a mobile device including a mobile device short-range wireless communication unit that performs wireless communication using a short-range wireless communication method, a mobile device control unit that executes control for transmitting a response signal to a request signal from the in-vehicle device, and a mobile device transmission unit that transmits a response signal to the in-vehicle device according to the control by the mobile device control unit. The in-vehicle device control unit executes control for transmitting the request signal when a short-range wireless communication network is formed with the mobile terminal by the in-vehicle device short-range wireless communication unit and a short-range wireless communication network is formed between the mobile terminal and the mobile device.

A communication system according to a third aspect of the invention includes an in-vehicle device including an in-vehicle device short-range wireless communication unit that performs wireless communication using a short-range wireless communication method, an in-vehicle device positioning apparatus that performs positioning, and an in-vehicle device control unit that executes control for transmitting a request signal; a mobile terminal including a mobile terminal positioning apparatus that performs positioning, and a mobile terminal control unit that executes control for transmitting a response signal transmission permission signal when a distance between the in-vehicle device and the mobile terminal is less than a prescribed threshold based on an in-vehicle device positioning result by the in-vehicle device positioning apparatus and a mobile terminal positioning result by the mobile terminal positioning apparatus; and a mobile device including a mobile device control unit that executes control for when a request signal from the in-vehicle device is received making an inquiry to the mobile terminal as to whether or not to transmit a response signal to the request signal when a request signal from the in-vehicle device is received and executes control for transmitting the response signal when the response signal transmission permission signal is received from the mobile terminal.

An in-vehicle device according to a fourth aspect of the invention includes an in-vehicle device short-range wireless communication unit that performs wireless communication using a short-range wireless communication method; and an in-vehicle device control unit that executes control for transmitting a request signal when a short-range wireless communication network is formed with the mobile terminal and the mobile device by the in-vehicle device short-range wireless communication unit.

An in-vehicle device according to a fifth aspect of the invention includes an in-vehicle device short-range wireless communication unit that performs wireless communication using a short-range wireless communication method; and an in-vehicle device control unit that executes control for transmitting a request signal when a short-range wireless communication network is formed with a mobile terminal and a short-range wireless communication network is formed between the mobile terminal and a mobile device by the in-vehicle device short-range wireless communication unit.

A mobile device in a wireless communication system including an in-vehicle device, a mobile terminal, and the mobile device according to a sixth aspect of the invention includes a mobile device short-range wireless communication unit that performs wireless communication using a short-range wireless communication method; a mobile device control unit that executes control for transmitting a response signal to a request signal from the in-vehicle device when a short-range wireless communication network is formed with the mobile terminal and a short-range wireless communication network is formed between the mobile terminal and the in-vehicle device by the mobile device short-range wireless communication unit; and a mobile device transmission unit that transmits a response signal to the in-vehicle device according to the control by the mobile device control unit.

A mobile device in a wireless communication system including an in-vehicle device, a mobile terminal, and the mobile device according to a seventh aspect of the invention includes a mobile device short-range wireless communication unit that performs wireless communication using a short-range wireless communication method; a mobile device control unit that executes control for transmitting a response signal to a request signal from the in-vehicle device when a short-range wireless communication network is formed with the in-vehicle device and a short-range wireless communication network is formed between the mobile terminal and the in-vehicle device by the mobile device short-range wireless communication unit; and a mobile device transmission unit that transmits a response signal to the in-vehicle device according to the control by the mobile device control unit.

A communication method used by a communication system including an in-vehicle device, a mobile terminal, and a mobile device according to an eighth aspect of the invention includes executing a process of forming a short-range wireless communication network between the in-vehicle device and the mobile terminal and between the in-vehicle device and the mobile device; and operating the in-vehicle device to execute control for transmitting a request signal when a short-range wireless communication network is formed between the in-vehicle device and the mobile terminal and between the in-vehicle device and the mobile device.

A communication method used by a communication system including an in-vehicle device, a mobile terminal, and a mobile device according to a ninth aspect of the invention includes executing a process of forming a short-range wireless communication network between the in-vehicle device and the mobile terminal and between the mobile terminal and the mobile device; and operating the mobile device to execute control for transmitting a request signal when a short-range wireless communication network is formed between the in-vehicle device and the mobile terminal and between the mobile terminal and the mobile device.

A communication system according to a tenth aspect of the invention includes: a mobile terminal including a first communication unit that performs wireless communication using a prescribed communication method; a mobile device including a second communication unit that performs wireless communication using the prescribed communication method, a mobile device reception unit that receives a request signal, a mobile device control unit that controls transmission of a response signal corresponding to the request signal when the mobile device reception unit receives the request signal, and a mobile device transmission unit that transmits a response signal according to control by the mobile device control unit; and an in-vehicle device including a third communication unit that performs wireless communication using the prescribed communication method, a memory that stores the formation of a prescribed network by the prescribed communication method as a determination condition, and an in-vehicle device control unit that determines whether the determination condition is met based on information communicated by the third communication unit and that executes control for transmitting the request signal when it is determined that the condition is met.

According to the disclosed examples, security in communication between a mobile device and an in-vehicle device can be improved.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram showing an example of a communication system according to the invention;

FIG. 2 is a diagram showing an example of an in-vehicle device according to the invention;

FIG. 3 is a diagram showing an example of a mobile terminal according to the invention;

FIG. 4 is a diagram showing an example of a mobile device according to the invention;

FIG. 5 is a flow chart showing an example of operations of the communication system according to the invention;

FIG. 6 is a diagram showing a modification of the in-vehicle device according to the invention;

FIG. 7 is a diagram showing a modification of the mobile terminal according to the invention;

FIG. 8 is a flow chart showing a modification of operations of the communication system according to the invention;

FIG. 9 is a diagram showing a modification of the communication system according to the invention;

FIG. 10 is a diagram showing an example of a wireless apparatus according to the invention;

FIG. 11 is a diagram showing a modification of the in-vehicle device according to the invention; and

FIGS. 12A and 12B are flow charts showing a modification of operations of the communication system according to the invention.

### DETAILED DESCRIPTION OF EMBODIMENT

Next, an embodiment of the invention will be described based on the following examples with reference to the drawings. Moreover, in all of the drawings used to describe the examples, components with like functions will be denoted by like reference numerals and redundant descriptions will be omitted.

### Example

### Communication System

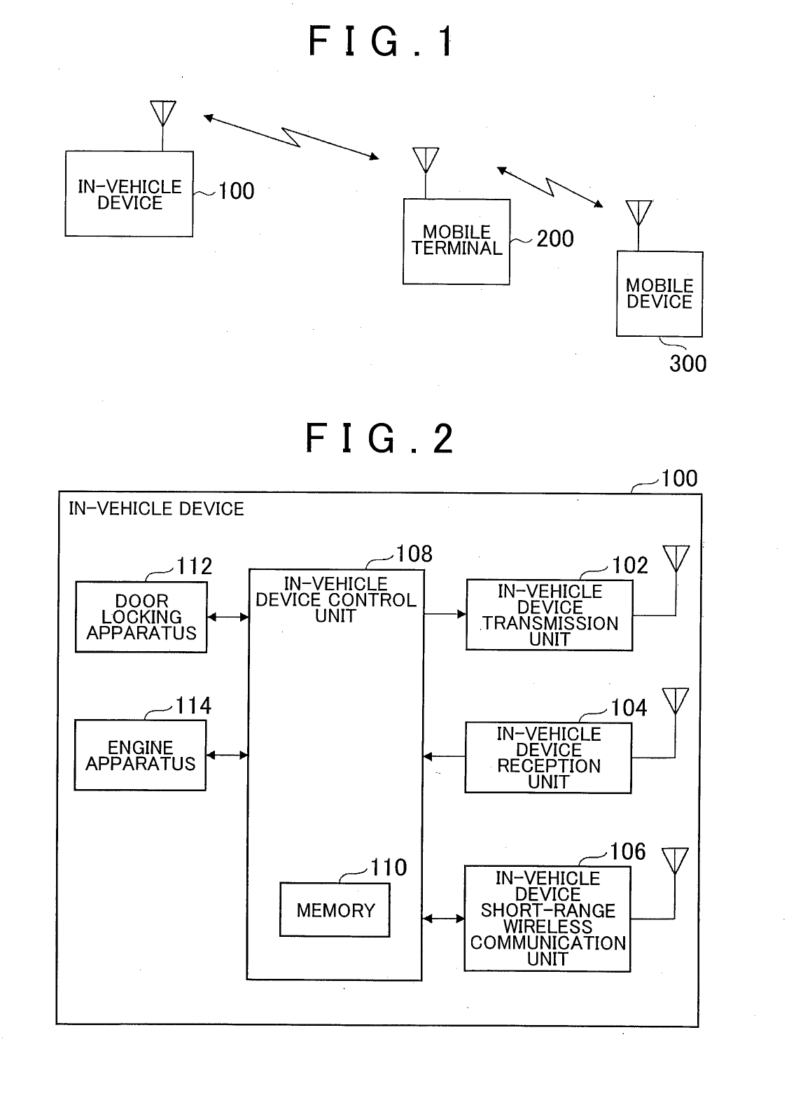

FIG. 1 shows an example of a communication system.

The communication system includes an in-vehicle device 100, a mobile terminal 200, and a mobile device 300. The in-vehicle device 100 favorably functions as a gateway (G/W) apparatus to a wide area network (WAN). In addition, the mobile terminal 200 favorably functions as a G/W apparatus to a WAN. Specific examples of the mobile terminal 200 include a mobile phone and a mobile information terminal.

The in-vehicle device 100 is mounted to a mobile body such as a vehicle. In the example of the communication system, the in-vehicle device 100 is mounted to a vehicle. The mobile terminal 200 and the mobile device 300 are favorably carried by a user.

A star-shaped network is favorably constituted among the in-vehicle device 100, the mobile terminal 200, and the mobile device 300. For example, a short-range wireless communication network is formed between the in-vehicle device 100 and the mobile terminal 200 and between the mobile terminal 200 and the mobile device 300. In this case, in the short-range wireless communication networks, the mobile terminal 200 functions as a hub and the in-vehicle device 100 and the mobile device 300 function as nodes. Alternatively, a short-range wireless communication network may be formed between the in-vehicle device 100 and the mobile terminal 200 and between the in-vehicle device 100 and the mobile device 300. In this case, in the short-range wireless communication networks, the in-vehicle device 100 functions as a hub and the mobile terminal 200 and the mobile device 300 function as nodes.

Specific examples of the short-range wireless communication network include a body area network (BAN) based on the IEEE802.15.6 standard, Bluetooth (registered trademark) based on the IEEE802.15.1 standard, Bluetooth Low Energy (BLE), and Zigbee (registered trademark) based on the IEEE802.15.4 standard. In the example of the communication system, a BAN is applied. A similar description applies in cases where other short-range wireless communication networks are applied.

In the example of the communication system, a case where the mobile terminal 200 functions as a hub will be mainly described. A similar description applies in a case where the in-vehicle device 100 functions as a hub.

When the mobile device 300 detects a request signal from the in-vehicle device 100, the mobile device 300 determines whether or not a short-range wireless communication network is formed between the mobile device 300 itself and the mobile terminal 200 and a short-range wireless communication network is formed between the in-vehicle device 100 and the mobile terminal 200. The mobile device 300 favorably determines whether or not the mobile device 300 itself forms a single short-range wireless communication network with the in-vehicle device 100 and the mobile terminal 200/When the mobile device 300 determines that a short-range wireless communication network is formed, the mobile device 300 transmits a response signal to the request signal to the in-vehicle device 100.

When the in-vehicle device 100 functions as a hub, upon detecting a request signal from the in-vehicle device 100, the mobile device 300 determines whether or not a short-range wireless communication network is formed between the mobile device 300 itself and the in-vehicle device 100 and a short-range wireless communication network is formed between the in-vehicle device 100 and the mobile terminal 200. The mobile device 300 favorably determines whether or not the mobile device 300 itself forms a single short-range wireless communication network with the in-vehicle device 100 and the mobile terminal 200. When the mobile device 300 determines that a short-range wireless communication network is formed, the mobile device 300 transmits a response signal to the request signal to the in-vehicle device 100.

As a result of intercommunication performed between the in-vehicle device 100 and the mobile device 300 after the response signal is transmitted from the mobile device 300 to the in-vehicle device 100, locking or unlocking of the doors of the vehicle on which the in-vehicle device 100 is mounted or starting of the engine of the vehicle is executed.

### <In-Vehicle Device 100>

FIG. 2 shows an example of the in-vehicle device 100.

The in-vehicle device 100 includes an in-vehicle device transmission unit 102, an in-vehicle device reception unit 104, an in-vehicle device short-range wireless communication unit 106, and an in-vehicle device control unit 108. The in-vehicle device control unit 108 has a memory 110 and a storage unit 115 and is electrically connected to a door locking apparatus 112 and an engine apparatus 114.

The in-vehicle device transmission unit 102 is connected to the in-vehicle device control unit 108. The in-vehicle device transmission unit 102 wirelessly transmits a request signal to the periphery of a vehicle on which the in-vehicle device 100 is mounted. In an example of the in-vehicle device transmission unit 102, the in-vehicle device transmission unit 102 is favorably built into a door handle of the vehicle. The in-vehicle device transmission unit 102 modulates the request signal inputted from the in-vehicle device control unit 108 into a radio wave in a low frequency (LF) band and wirelessly transmits the modulated signal via a transmission antenna.

The in-vehicle device control unit 108 is constituted by, for example, an ECU. The memory 110 included in the in-vehicle device control unit 108 is, for example, a non-volatile memory and stores a same ID code as an ID code stored in the mobile device 300.

The in-vehicle device control unit 108 generates a request signal and inputs the request signal to the in-vehicle device transmission unit 102. The in-vehicle device control unit 108 favorably generates a request signal at a prescribed period. The prescribed period is favorably set in advance.

The in-vehicle device control unit 108 collates whether or not the ID code included in the response signal from the mobile device 300 matches the ID code stored in the memory 110. When the in-vehicle device control unit 108 determines that the ID code included in the response signal from the mobile device 300 matches the ID code stored in the memory 110, the in-vehicle device control unit 108 assumes that a state exists in which prescribed control for locking or unlocking the doors of the vehicle, starting the engine of the vehicle, or the like can be executed. When the in-vehicle device control unit 108 recognizes that a door handle is touched by the user in the state in which the prescribed control can be executed, the in-vehicle device control unit 108 favorably unlocks the vehicle doors via the door locking apparatus 112. When the in-vehicle device control unit 108 recognizes that a brake pedal is depressed and an engine switch has been pressed in the state in which the prescribed control can be executed, the in-vehicle device control unit 108 favorably starts the engine via the engine apparatus 114.

The in-vehicle device reception unit 104 is connected to the in-vehicle device control unit 108. The in-vehicle device reception unit 104 demodulates a radio frequency (RF) band response signal received via a reception antenna and inputs the demodulated response signal to the in-vehicle device control unit 108.

The in-vehicle device short-range wireless communication unit 106 is connected to the in-vehicle device control unit 108. The in-vehicle device short-range wireless communication unit 106 performs wireless communication with the mobile terminal 200. In addition, the in-vehicle device short-range wireless communication unit 106 may sometimes perform wireless communication with the mobile device 300.

The in-vehicle device short-range wireless communication unit 106 forms a short-range wireless communication network with the mobile terminal 200. In this case, a short-range wireless communication network may be formed between the mobile terminal 200 and the mobile device 300.

In addition, the in-vehicle device short-range wireless communication unit 106 may sometimes form a short-range wireless communication network between the mobile terminal 200 and the mobile device 300. Information for forming a short-range wireless communication network may be set in advance. In this case, a condition of a formed short-range wireless communication network is stored in advance in the memory 110, the in-vehicle device control unit 108 determines whether the condition is met based on information communicated by the in-vehicle device short-range wireless communication unit 106, and executes control for transmitting the request signal when it is determined that the condition is met. A condition of a formed short-range wireless communication network is information that defines devices to be connected by short-range wireless communication. In the present example, for example, establishment of connections between the in-vehicle device 100 and the mobile terminal 200 and between the mobile terminal 200 and the mobile device 300 by short-range wireless communication may be stored in the memory 110 as the determination condition. As a specific description method of the determination condition stored in the memory 110, any method can be used. Specifically, any method can be used as long as prescribed devices to be connected can be identified based on the information (determination condition) stored in the memory 110.

The door locking apparatus 112 is connected to the in-vehicle device control unit 108. The door locking apparatus 112 locks or unlocks the doors of the vehicle according to a control signal from the in-vehicle device control unit 108.

The engine apparatus 114 is connected to the in-vehicle device control unit 108. The engine apparatus 114 starts the engine according to a control signal from the in-vehicle device control unit 108.

### <Mobile Terminal 200>

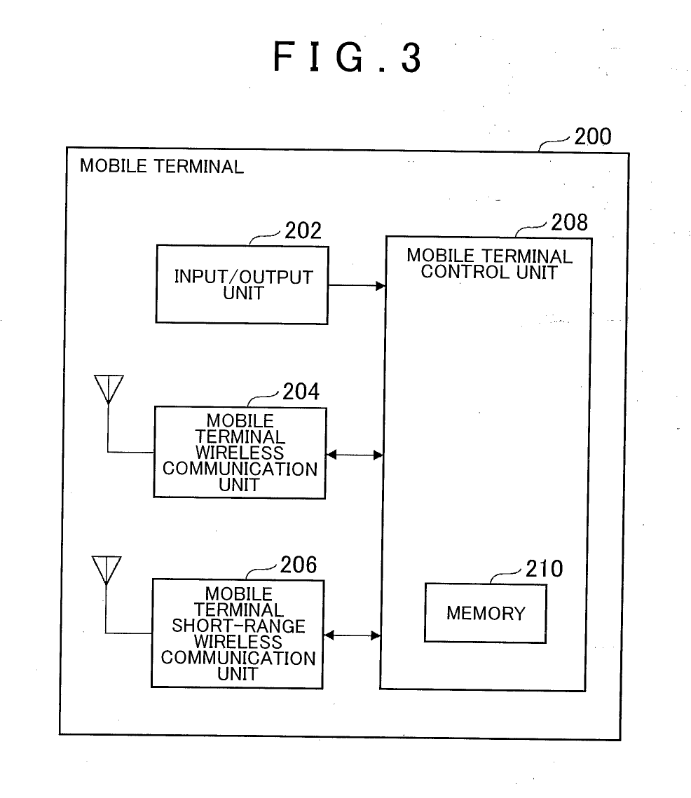

FIG. 3 shows an example of the mobile terminal 200.

The mobile terminal 200 includes an input/output unit 202, a mobile terminal wireless communication unit 204, a mobile terminal short-range wireless communication unit 206, and a mobile terminal control unit 208. The mobile terminal control unit 208 has a memory 210.

The input/output unit 202 is constituted by, for example, a keyboard and is an apparatus for issuing instructions and inputting data to the mobile terminal 200. Alternatively, the input/output unit 202 may be constituted by a touch panel. Alternatively, the input/output unit 202 is constituted by, for example, a microphone and is used to input voices uttered by the user. Such voices may include a message to a called party and an instruction to the mobile terminal 200. Specific examples of the instruction include those intended for applications.

In addition, the input/output unit 202 is constituted by, for example, a display and displays a processing status or a processing result of the mobile terminal 200. Alternatively, the input/output unit 202 may be constituted by, for example, a speaker and may output sounds to the user. Specific examples of the processing status and the processing result include those of applications. Specific examples of the display include a liquid crystal display (LCD) and an organic electro-luminescence (EL) display.

The mobile terminal wireless communication unit 204 is connected to the mobile terminal control unit 208. The mobile terminal wireless communication unit 204 performs wireless communication with a base station (not illustrated).

The mobile terminal control unit 208 is constituted by, for example, a central processing unit (CPU). The memory 210 included in the mobile terminal control unit 208 is, for example, a non-volatile memory and stores information necessary for forming a short-range wireless communication network with the in-vehicle device 100. The mobile terminal control unit 208 forms a short-range wireless communication network with at least one of the in-vehicle device 100 and the mobile device 300 by controlling the mobile terminal short-range wireless communication unit 206.

The mobile terminal short-range wireless communication unit 206 is connected to the mobile terminal control unit 208. The mobile terminal short-range wireless communication unit 206 performs wireless communication with at least one of the in-vehicle device 100 and the mobile device 300. The mobile terminal short-range wireless communication unit 206 forms a short-range wireless communication network with at least one of the in-vehicle device 100 and the mobile device 3′00. Information for forming the short-range wireless communication network is favorably set in advance and stored in the memory 210.

### <Mobile Device 300>

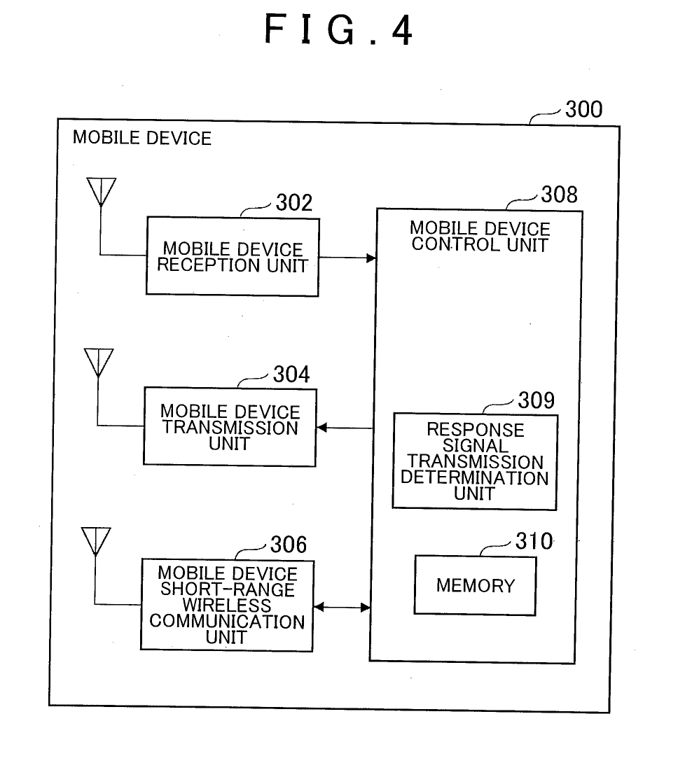

FIG. 4 shows an example of the mobile device 300.

The mobile device 300 includes a mobile device reception unit 302, a mobile device transmission unit 304, a mobile device short-range wireless communication unit 306, and a mobile device control unit 308. The mobile device control unit 308 has a response signal transmission determination unit 309 and a memory 310.

The mobile device reception unit 302 is connected to the mobile device control unit 308. The mobile device reception unit 302 receives an LF band request signal transmitted from the in-vehicle device 100 via a reception antenna. The mobile device reception unit 302 demodulates the request signal and inputs the demodulated signal to the mobile device control unit 308.

The mobile device transmission unit 304 is connected to the mobile device control unit 308. The mobile device transmission unit 304 wirelessly transmits a response signal to the request signal from the in-vehicle device 100. When a response signal is inputted from the mobile device control unit 308, the mobile device transmission unit 304 modulates the response signal to a radio wave in an ultrahigh frequency (UHF) band and transmits the modulated signal via a transmission antenna.

The mobile device short-range wireless communication unit 306 is connected to the mobile device control unit 308. The mobile device short-range wireless communication unit 306 performs wireless communication with at least one of the in-vehicle device 100 and the mobile terminal 200. The mobile device short-range wireless communication unit 306 forms a short-range wireless communication network with at least one of the in-vehicle device 100 and the mobile terminal 200. Information for forming the short-range wireless communication network is favorably set in advance and stored in the memory 310.

The mobile device control unit 308 has the response signal transmission determination unit 309. When a demodulated request signal is inputted to the mobile device control unit 308 from the mobile device reception unit 302, the response signal transmission determination unit 309 determines whether or not a short-range wireless communication network is formed with the mobile terminal 200 and a short-range wireless communication network is formed between the in-vehicle device 100 and the mobile terminal 200. When the response signal transmission determination unit 309 determines that a short-range wireless communication network is formed with the mobile terminal 200 and that a short-range wireless communication network is formed between the in-vehicle device 100 and the mobile terminal 200, the response signal transmission determination unit 309 generates a response signal to the request signal and inputs the response signal to the mobile device transmission unit 304. When the response signal transmission determination unit 309 determines that a short-range wireless communication network is not formed with the mobile terminal 200 or that a short-range wireless communication network is not formed between the in-vehicle device 100 and the mobile terminal 200, the response signal transmission determination unit 309 does not generate a response signal to the request signal and stands by.

In addition, when a demodulated request signal is inputted to the mobile device control unit 308 from the mobile device reception unit 302, the response signal transmission determination unit 309 determines whether or not a short-range wireless communication network is formed with the in-vehicle device 100 and a short-range wireless communication network is formed between the in-vehicle device 100 and the mobile terminal 200. When the response signal transmission determination unit 309 determines that a short-range wireless communication network is formed with the in-vehicle device 100 and that a short-range wireless communication network is formed between the in-vehicle device 100 and the mobile terminal 200, the response signal transmission determination unit 309 generates a response signal to the request signal and inputs the response signal to the mobile device transmission unit 304. When the response signal transmission determination unit 309 determines that a short-range wireless communication network is not formed with the in-vehicle device 100 or that a short-range wireless communication network is not formed between the in-vehicle device 100 and the mobile terminal 200, the response signal transmission determination unit 309 does not generate a response signal to the request signal and stands by.

The memory 310 of the mobile device control unit 308 stores an ID code of the mobile device 300. The mobile device control unit 308 creates a response signal including the ID code.

### <Operations of Communication System>

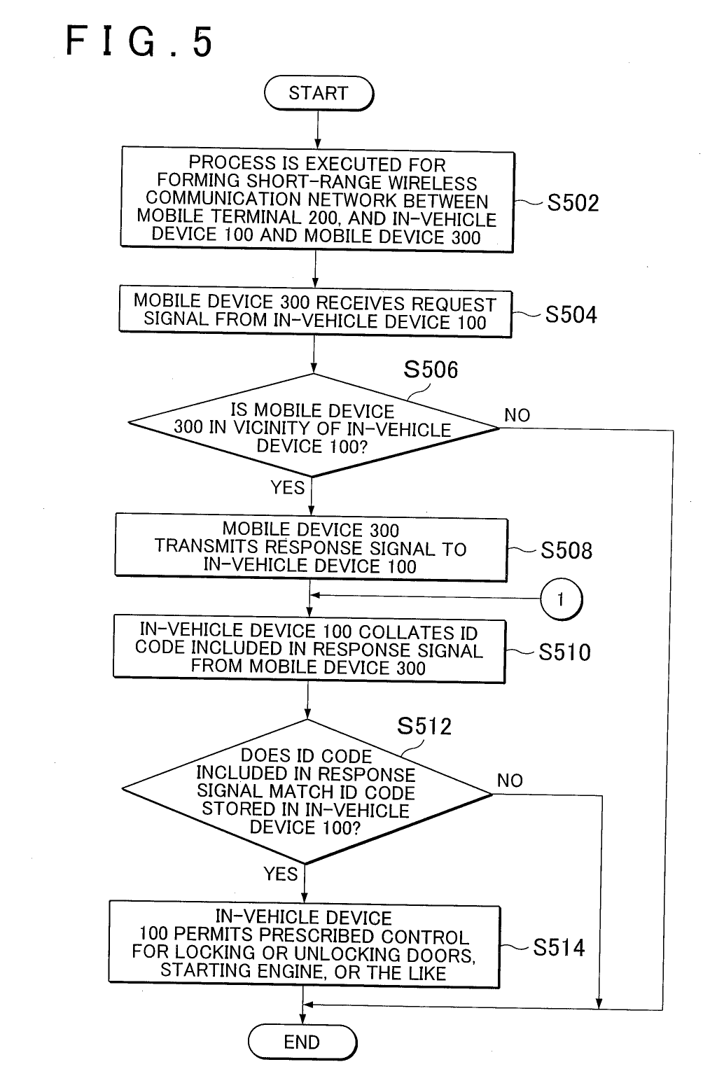

FIG. 5 is a flow chart showing an example of operations of the communication system.

In step S502, a process of forming a short-range wireless communication network between the mobile terminal 200, and the in-vehicle device 100 and the mobile device 300 is executed. Specifically, the mobile terminal 200 executes a connection process by short-range wireless communication with the in-vehicle device 100. In addition, the mobile terminal 200 executes a connection process by short-range wireless communication with the mobile device 300.

In step S504, the mobile device 300 receives a request signal from the in-vehicle device 100.

In step S506, the mobile device 300 determines whether or not the mobile device 300 is positioned in the vicinity of the in-vehicle device 100. Specifically, the response signal transmission determination unit 309 determines whether or not the mobile device 300 is positioned in the vicinity of the in-vehicle device 100 by determining whether or not a short-range wireless communication network is formed with the mobile terminal 200 and a short-range wireless communication network is formed between the in-vehicle device 100 and the mobile terminal 200. When the response signal transmission determination unit 309 determines that a short-range wireless communication network is formed with the mobile terminal 200 and that a short-range wireless communication network is formed between the in-vehicle device 100 and the mobile terminal 200, the response signal transmission determination unit 309 determines that the mobile device 300 is positioned in the vicinity of the in-vehicle device 100. When the response signal transmission determination unit 309 determines that a short-range wireless communication network is not formed with the mobile terminal 200 or that a short-range wireless communication network is not formed between the in-vehicle device 100 and the mobile terminal 200, the response signal transmission determination unit 309 determines that the mobile device 300 is not positioned in the vicinity of the in-vehicle device 100.

In step S508, the mobile device 300 transmits a response signal to the in-vehicle device 100 when it is determined in step S506 that the mobile device 300 is positioned in the vicinity of the in-vehicle device 100. The mobile device control unit 308 generates a response signal to the request signal and performs control for transmitting the response signal from the mobile device transmission unit 304.

In step S510, the in-vehicle device 100 collates an ID code included in the response signal from the mobile device 300. The response signal from the mobile device 300 is received by the in-vehicle device reception unit 104 of the in-vehicle device 100 and inputted to the in-vehicle device control unit 108. The in-vehicle device control unit 108 collates the ID code included in the response signal with an ID code stored in the memory 110.

In step S512, the in-vehicle device 100 determines whether or not the ID code included in the response signal matches the ID code stored in the memory 110. The in-vehicle device control unit 108 determines whether or not the ID code included in the response signal matches the ID code stored in the memory 110.

In step S514, the in-vehicle device 100 permits prescribed control for locking or unlocking the doors, starting the engine, or the like when it is determined in step S512 that the ID codes match. When it is determined that the ID code included in the response signal matches the ID code stored in the memory 110, the in-vehicle device control unit 108 executes control for permitting the door locking apparatus 112 to lock or unlock the doors. In addition, the in-vehicle device control unit 108 executes control for permitting the engine apparatus 114 to start the engine.

When it is determined in step S506 that the mobile device 300 is not in the vicinity of the in-vehicle device 100 or when the in-vehicle device 100 determines in step S512 that the ID code included in the response signal does not match the stored ID code, the process is terminated without performing further operations.

According to an example of the communication system, a short-range wireless communication network is formed among the in-vehicle device 100, the mobile terminal 200, and the mobile device 300. Specifically, a short-range wireless communication network is formed between the in-vehicle device 100 and the mobile terminal 200 and between the mobile terminal 200 and the mobile device 300. In addition, a short-range wireless communication network is formed between the in-vehicle device 100, and the mobile terminal 200 and the mobile device 300. For example, when a BAN is applied to the short-range wireless communication network, a communication radius thereof is around 2 m. When a short-range wireless communication network is formed, the mobile device 300 transmits a response signal to the request signal from the in-vehicle device 100. This is because the mobile device 300 is determined to be positioned in the vicinity of the in-vehicle device 100. Therefore, when a signal copied from a request signal from the in-vehicle device 100 is received by the mobile device 300, the mobile device 300 does not transmit a response signal. In this manner, by arranging a response signal to be transmitted when a short-range wireless communication network is formed in the vicinity of the user, the mobile device can be prevented from relaying a passively transmitted response signal. Since a response signal can be prevented from being relayed, theft due to a relayed response signal controlling the vehicle can be prevented. In addition, a highly robust smart key system can be constructed.

Furthermore, by arranging the in-vehicle device 100 or the mobile terminal 200 as a node that functions as a hub, one of the in-vehicle device 100 and the mobile terminal 200 can be modified by performing a process of identifying a connection partner. In other words, there is no need to register and delete ID codes or the like related to security.

### <First Modification>

This modification of the communication system differs from the example described above in the functions of the in-vehicle device 100 and the mobile device 300.

A process of forming a short-range wireless communication network between the in-vehicle device 100 and the mobile terminal 200 and a process of forming a short-range wireless communication network between the mobile terminal 200 and the mobile device 300 are executed. Specifically, the mobile terminal 200 executes a connection process by short-range wireless communication with the in-vehicle device 100 and the mobile device 300.

The in-vehicle device 100 may be arranged to execute a connection process by short-range wireless communication with the mobile terminal 200 and the mobile device 300.

The in-vehicle device 100 determines whether or not a short-range wireless communication network is formed with the mobile terminal 200 and a short-range wireless communication network is formed between the mobile terminal 200 and the mobile device 300. The in-vehicle device control unit 108 determines whether or not the mobile device 300 is positioned in the vicinity of the in-vehicle device 100 by determining whether or not a short-range wireless communication network is formed with the mobile terminal 200 and a short-range wireless communication network is formed between the mobile terminal 200 and the mobile device 300.

The in-vehicle device 100 transmits a request signal when the in-vehicle device 100 determines that a short-range wireless communication network is formed with the mobile terminal 200 and that a short-range wireless communication network is formed between the mobile terminal 200 and the mobile device 300.

The in-vehicle device 100 may be arranged to determine whether or not a short-range wireless communication network is formed with the mobile terminal 200 and the mobile device 300. The in-vehicle device control unit 108 determines whether or not the mobile device 300 is positioned in the vicinity of the in-vehicle device 100 by determining whether or not a short-range wireless communication network is formed with the mobile terminal 200 and the mobile device 300.

The in-vehicle device 100 transmits a request signal when the in-vehicle device 100 determines that a short-range wireless communication network is formed with the mobile terminal 200 and the mobile device 300.

The mobile device 300 receives the request signal from the in-vehicle device 100. The mobile device 300 transmits a response signal to the in-vehicle device 100. The mobile device control unit 308 generates a response signal to the request signal and performs control for transmitting the response signal from the mobile device transmission unit 304.

The in-vehicle, device 100 collates an ID code included in the response signal from the mobile device 300. The response signal from the mobile device 300 is received by the in-vehicle device reception unit 104 of the in-vehicle device 100 and inputted to the in-vehicle device control unit 108. The in-vehicle device control unit 108 collates the ID code included in the response signal with an ID code stored in the memory 110.

The in-vehicle device 100 determines whether or not the ID code included in the response signal matches the ID code stored in the memory 110. The in-vehicle device control unit 108 determines whether or not the ID code included in the response signal matches the ID code stored in the memory 110.

When the in-vehicle device 100 determines that the ID code included in the response signal matches the ID code stored in the memory 110, the in-vehicle device 100 permits prescribed control for locking or unlocking the doors, starting the engine, or the like. When the in-vehicle device control unit 108 determines that the ID code included in the response signal matches the ID code stored in the memory 110, the in-vehicle device control unit 108 executes control for permitting the door locking apparatus 112 to lock or unlock the doors. In addition, the in-vehicle device control unit 108 executes control for permitting the engine apparatus 114 to start the engine.

When the in-vehicle device 100 determines that a short-range wireless communication network is not formed with the mobile terminal 200 or that a short-range wireless communication network is not formed between the mobile terminal 200 and the mobile device 300, the process is terminated without performing further operations.

In addition, when the in-vehicle device 100 determines that a short-range wireless communication network is not formed with the mobile terminal 200 or that a short-range wireless communication network is not formed with the mobile device 300, the process may be terminated without performing further operations.

Furthermore, when the in-vehicle device 100 determines that the ID code included in the response signal does not match the stored ID code, the process is terminated without performing further operations.

According to the modification of the communication system, a short-range wireless communication network is formed between the in-vehicle device 100 and the mobile terminal 200 and between the mobile terminal 200 and the mobile device 300. Alternatively, a short-range wireless communication network may be formed between the in-vehicle device 100, and the mobile terminal 200 and the mobile device 300. For example, when a BAN is applied to the short-range wireless communication network, a communication radius thereof is around 2 m. The in-vehicle device 100 transmits a request signal when a short-range wireless communication network is formed. This is because the mobile device 300 is determined to be positioned in the vicinity of the in-vehicle device 100. The mobile device 300 transmits a response signal to the request signal. On the other hand, the in-vehicle device 100 does not transmit a request signal when a short-range wireless communication network is not formed. In this manner, by having a request signal transmitted when a short-range wireless communication network is formed, copying of the request signal can be prevented. Since a request signal can be prevented from being copied, a pseudo signal can be prevented from being transmitted by a communication apparatus in the possession of a thief impersonating as the user. Therefore, a response to a pseudo signal is prevented from being transmitted from a mobile device in the possession of the user and the vehicle is prevented from being controlled by the response.

Furthermore, by arranging the in-vehicle device 100 or the mobile terminal 200 as a node that functions as a hub, one of the in-vehicle device 100 and the mobile terminal 200 can be modified by performing a process of identifying a connection partner. In other words, there is no need to register and delete ID codes or the like related to security.

The example described above and the first modification may be combined together. Specifically, a request signal is transmitted from the in-vehicle device 100 when a short-range wireless communication network is formed. When the mobile device 300 determines that a short-range wireless communication network is formed, the mobile device 300 transmits a response signal.

### <Second Modification>

This modification of the communication system differs from the example described above in the configurations of the in-vehicle device 100 and the mobile terminal 200.

### <In-Vehicle Device 100>

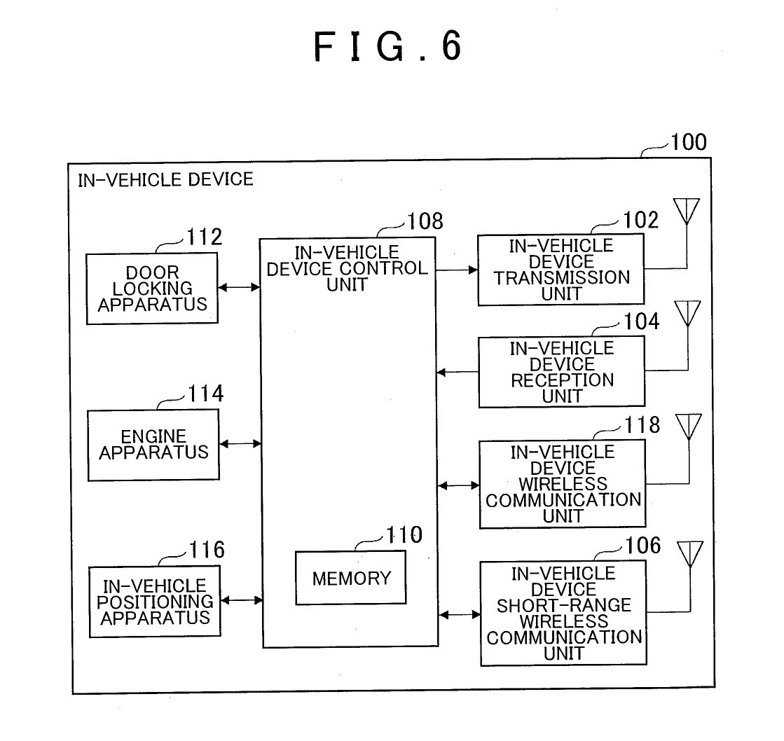

FIG. 6 shows a modification of the in-vehicle device 100.

The in-vehicle device 100 is the in-vehicle device described with reference to FIG. 2 including an in-vehicle device positioning apparatus 116 and an in-vehicle device wireless communication unit 118.

The in-vehicle device positioning apparatus 116 is connected to the in-vehicle device control unit 108. The in-vehicle device positioning apparatus 116 obtains a position of a vehicle mounted with the in-vehicle device 100 by positioning the in-vehicle device 100. A global navigation satellite system(s) (GNSS) reception apparatus is applied to the modification of the in-vehicle device positioning apparatus 116. A positioning apparatus using a global positioning system (GPS) may be applied to the in-vehicle device positioning apparatus 116. The in-vehicle device positioning apparatus 116 inputs a positioning result to the in-vehicle device control unit 108.

The in-vehicle device control unit 108 causes the in-vehicle device positioning apparatus 116 to perform positioning when position information is requested by the mobile terminal 200. The in-vehicle device control unit 108 inputs a positioning result from the in-vehicle device positioning apparatus 116 to the in-vehicle device wireless communication unit 118.

The in-vehicle device wireless communication unit 118 is connected to the in-vehicle device control unit 108. The in-vehicle device wireless communication unit 118 performs wireless communication with the mobile terminal 200 through a communication network. The in-vehicle device wireless communication unit 118 is constituted by, for example, a data communication module (DCM). The in-vehicle device wireless communication unit 118 wirelessly transmits a positioning result by the in-vehicle device positioning apparatus 116 to the mobile terminal 200.

### <Mobile Terminal 200>

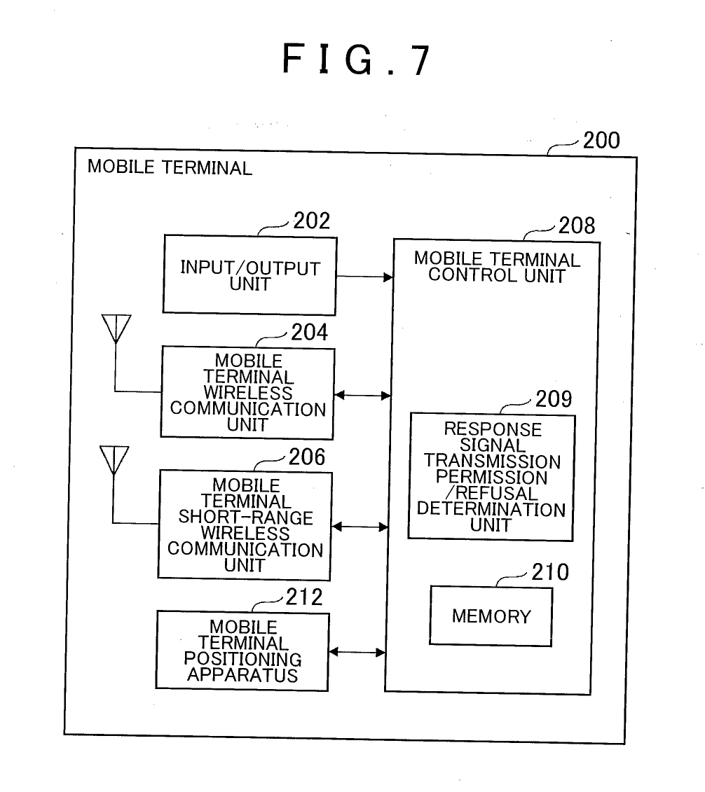

FIG. 7 shows a modification of the mobile terminal 200.

The mobile terminal 200 is the mobile terminal described with reference to FIG. 3 including a mobile terminal positioning apparatus 212.

The mobile terminal positioning apparatus 212 is connected to the mobile terminal control unit 208. The mobile terminal positioning apparatus 212 positions the mobile terminal 200. A GNSS reception apparatus is applied to the modification of the mobile terminal positioning apparatus 212. A positioning apparatus using a GPS may be applied to the mobile terminal positioning apparatus 212. The mobile terminal positioning apparatus 212 inputs a positioning result to the mobile terminal control unit 208.

The mobile terminal wireless communication unit 204 receives a positioning result transmitted from the in-vehicle device 100 through a communication network. The mobile terminal wireless communication unit 204 inputs the received positioning result to the mobile terminal control unit 208.

The mobile terminal control unit 208 has a response signal transmission permission/refusal determination unit 209. The response signal transmission permission/refusal determination unit 209 requests the in-vehicle device 100 for position information when a signal inquiring whether or not a response signal to the request signal is to be transmitted (hereinafter, referred to as a “response signal transmission inquiry signal”) is received from the mobile device 300.

In addition, the response signal transmission permission/refusal determination unit 209 causes the mobile terminal positioning apparatus 212 to execute positioning when the response signal transmission inquiry signal is received. The response signal transmission permission/refusal determination unit 209 determines whether or not the mobile terminal 200 is in the vicinity of the in-vehicle device 100 based on a positioning result from the mobile terminal positioning apparatus 212 and a positioning result from the mobile terminal wireless communication unit 204. The response signal transmission permission/refusal determination unit 209 may be arranged to determine that the mobile terminal 200 is in the vicinity of the in-vehicle device 100 when a distance between the positioning result from the mobile terminal positioning apparatus 212 and the positioning result from the mobile terminal wireless communication unit 204 is less than a prescribed threshold. The threshold used when determining whether or not the mobile terminal 200 is in the vicinity of the in-vehicle device 100 is favorably around several m. When the response signal transmission permission/refusal determination unit 209 determines that the mobile terminal 200 is in the vicinity of the in-vehicle device 100, the response signal transmission permission/refusal determination unit 209 performs control for transmitting a signal for permitting transmission of a response signal (hereinafter, referred to as a “response signal transmission permission signal”) to the mobile device 300. The response signal transmission permission/refusal determination unit 209 inputs the response signal transmission permission signal to the mobile terminal short-range wireless communication unit 206.

The mobile terminal short-range wireless communication unit 206 wirelessly transmits the response signal transmission permission signal from the mobile terminal control unit 208 to the mobile device 300.

### <Mobile Device 300>

The mobile device 300 is approximately the same as that shown in FIG. 4.

The response signal transmission determination unit 309 generates a response signal transmission inquiry signal when a demodulated request signal is inputted from the mobile device reception unit 302. The response signal transmission determination unit 309 executes control for transmitting the response signal transmission inquiry signal from the mobile device short-range wireless communication unit 306. When a response signal transmission permission signal with respect to the response signal transmission inquiry signal is inputted to the mobile device control unit 308, the response signal transmission determination unit 309 generates a response signal to the request signal and inputs the response signal to the mobile device transmission unit 304. When a response signal transmission permission signal with respect to the response signal transmission inquiry signal is not inputted, the response signal transmission determination unit 309 does not generate a response signal to the request signal and stands by.

### <Operations of Communication System>

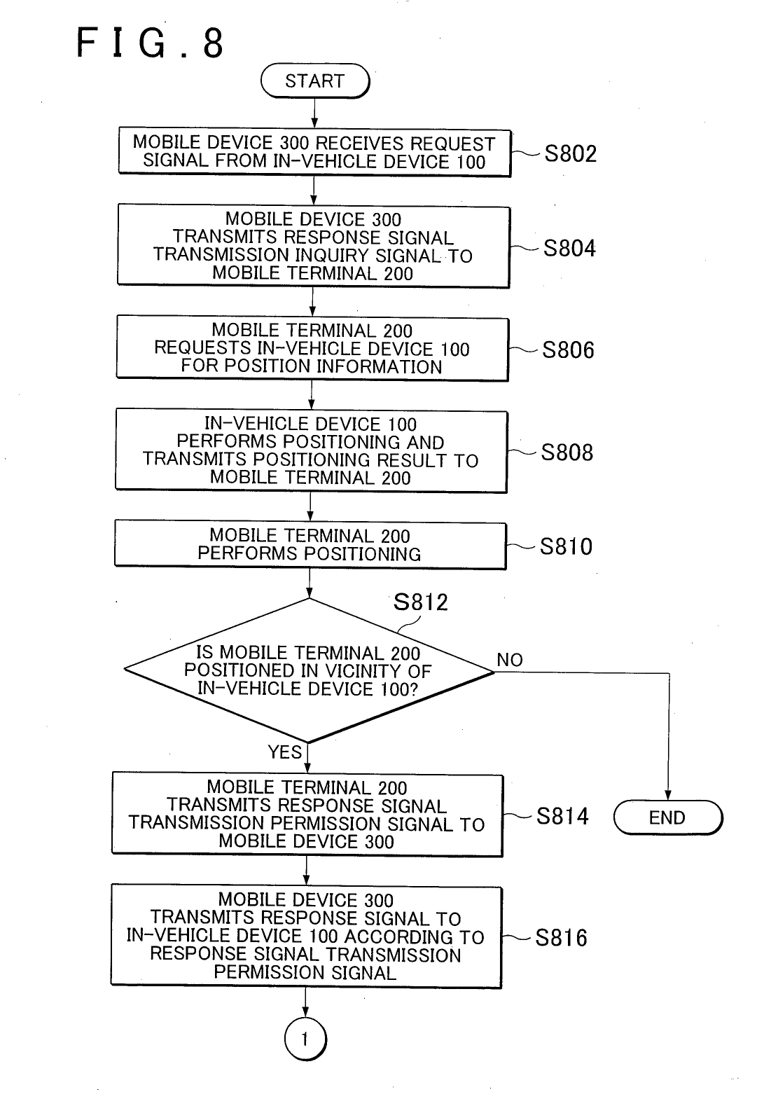

FIG. 8 is a flow chart showing a modification of operations of the communication system.

Prior to step S802, a process for forming a short-range wireless communication network between the mobile terminal 200 and the mobile device 300 is favorably executed.

In step S802, the mobile device 300 receives a request signal from the in-vehicle device 100.

In step S804, the mobile device 300 transmits a response signal transmission inquiry signal to the mobile terminal 200. Specifically, the response signal transmission determination unit 309 executes control for transmitting the response signal transmission inquiry signal to the mobile terminal 200.

In step S806, the mobile terminal 200 requests the in-vehicle device 100 for position information. Specifically, the response signal transmission permission/refusal determination unit 209 executes control for requesting the in-vehicle device 100 for position information. When requesting the in-vehicle device 100 for position information, a process for forming a short-range wireless communication network between the mobile terminal 200 and the mobile device 300 is favorably executed.

In step S808, the in-vehicle device 100 performs positioning and transmits a positioning result to the mobile terminal 200.

In step S810, the mobile terminal 200 performs positioning. Specifically, the mobile terminal positioning apparatus 212 executes positioning.

In step S812, the mobile terminal 200 determines whether or not the mobile terminal 200 is positioned in the vicinity of the in-vehicle device 100. The response signal transmission permission/refusal determination unit 209 determines whether or not the mobile terminal 200 is in the vicinity of the in-vehicle device 100 based on a positioning result of the mobile terminal 200 and a positioning result from the in-vehicle device 100.

In step S814, when the mobile terminal 200 determines that the mobile terminal 200 is positioned in the vicinity of the in-vehicle device 100, the mobile terminal 200 transmits a response signal transmission permission signal to the mobile device 300. Specifically, when the response signal transmission permission/refusal determination unit 209 determines that the mobile terminal 200 is positioned in the vicinity of the in-vehicle device 100, the response signal transmission permission/refusal determination unit 209 executes control for transmitting a response signal transmission permission signal to the mobile device 300.

In step S816, the mobile device 300 transmits a response signal to the in-vehicle device 100 according to the response signal transmission permission signal.

After the process of step S816, processes of step S510 and subsequent steps in FIG. 5 are executed.

When it is determined in step S812 that the mobile terminal 200 is not positioned in the vicinity of the in-vehicle device 100, the process is terminated without performing further operations.

According to the modification of the communication system, by using positioning results of a GNSS or the like when determining a positional relationship between the in-vehicle device 100 and the mobile device 300, even when a short-range wireless communication network is not formed among the in-vehicle device 100, the mobile terminal 200, and the mobile device 300, the mobile device 300 can transmit a response signal to a request signal while ensuring security. In other words, when a short-range wireless communication network is formed between the mobile terminal 200 and the mobile device 300, the mobile device 300 can transmit a response signal to a request signal from the in-vehicle device 100.

### <Third Modification>

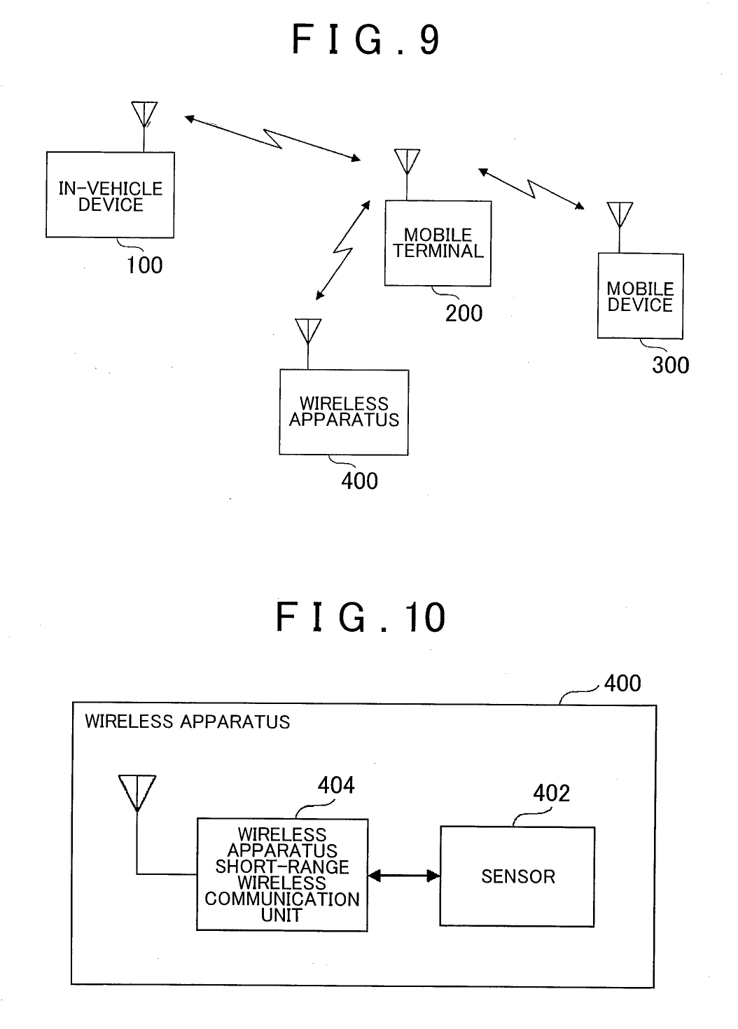

FIG. 9 shows a modification of the communication system.

This modification of the communication system differs from the example described above in that the communication system includes a wireless apparatus 400 in addition to the in-vehicle device 100, the mobile terminal 200, and the mobile device 300. While a single wireless apparatus 400 is shown in FIG. 9, a plurality of wireless apparatuses 400 are favorably provided. The wireless apparatuses 400 are favorably disposed on a surface of a body, inside the body, and near poles of the body.

### <Wireless Apparatus 400>

FIG. 10 shows an example of the wireless apparatus 400.

The wireless apparatus 400 includes a sensor 402 and a wireless apparatus short-range wireless communication unit 404.

The sensor 402 detects biometric information of the user on which the wireless apparatus 400 is disposed. Specific examples of the sensor 402 include sensors that detect biometric information such as a perspiration sensor, a pulse/temperature sensor, a blood sensor, and a pacemaker. Biometric information detected by the sensor 402 is inputted to the wireless apparatus short-range wireless communication unit 404.

The wireless apparatus short-range wireless communication unit 404 wirelessly transmits biometric information obtained from the sensor 402, to the mobile terminal 200. A short-range wireless communication network is favorably formed between the mobile terminal 200 and the wireless apparatus 400. Specific examples of the short-range wireless communication network include a BAN based on the IEEE802.15.6 standard, Bluetooth (registered trademark) based on the IEEE802.15.1 standard, BLE, and Zigbee (registered trademark) based on the IEEE802.15.4 standard. In an example of the communication system, a BAN is applied. A similar description applies in cases where other short-range wireless communication networks are applied. Biometric information may be regularly or irregularly transmitted from the wireless apparatus 400 to the mobile terminal 200. For example, a short-range wireless communication network may be formed between the mobile terminal 200 and the wireless apparatus 400, whereby biometric information may be transmitted from the wireless apparatus 400 to the mobile terminal 200.

### <Mobile Terminal 200>

The mobile terminal 200 is approximately the same as that shown in FIG. 3.

Biometric information from the wireless apparatus 400 is received by the mobile terminal short-range wireless communication unit 206 and inputted to the mobile terminal control unit 208. The mobile terminal control unit 208 performs control for transmitting the biometric information from the mobile terminal wireless communication unit 204 to the in-vehicle device 100. The biometric information obtained from the wireless apparatus 400 is wirelessly transmitted from the mobile terminal 200 to the in-vehicle device 100. For example, a short-range wireless communication network may be formed between the mobile terminal 200 and the in-vehicle device 100, whereby the biometric information may be transmitted from the mobile terminal 200 to the in-vehicle device 100 via the short-range wireless communication network. Alternatively, for example, a connection may be established between the mobile terminal 200 and the in-vehicle device 100 via a WAN, whereby the biometric information may be transmitted from the mobile terminal 200 to the in-vehicle device 100 via the WAN.

### <In-Vehicle Device 100>

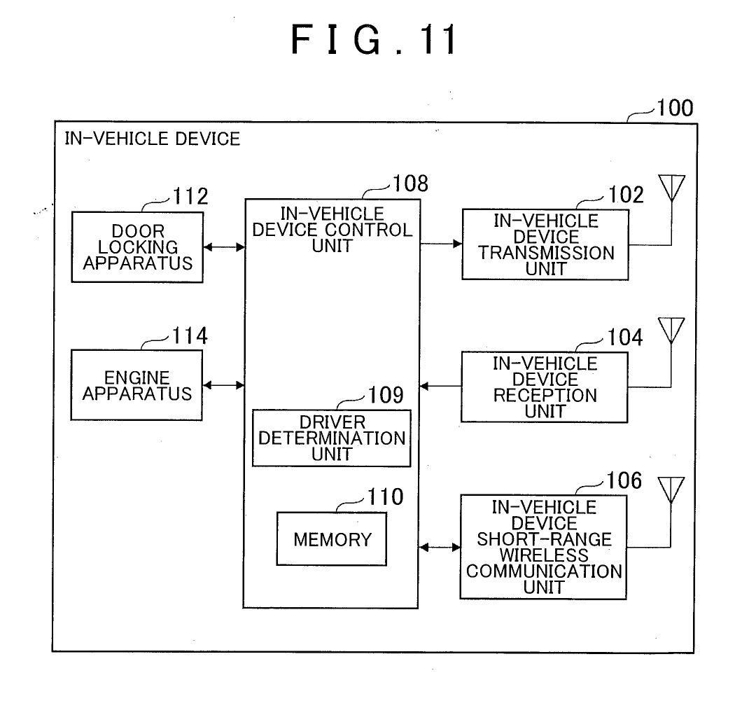

FIG. 11 shows a modification of the in-vehicle device 100. The in-vehicle device 100 is the in-vehicle device described with reference to FIG. 2 in which a driver determination unit 109 is included in the in-vehicle device control unit 108. Biometric information obtained from the mobile terminal 200 is inputted to the driver determination unit 109. Biometric information of the driver is stored in the memory 110 of the in-vehicle device control unit 108. The driver determination unit 109 determines whether or not the biometric information obtained from the mobile terminal 200 belongs to the driver of the vehicle on which the in-vehicle device 100 is mounted, based on the biometric information obtained from the mobile terminal 200 and the biometric information stored in the memory 110. When the driver determination unit 109 determines that the biometric information obtained from the mobile terminal 200 belongs to the driver of the vehicle on which the in-vehicle device 100 is mounted, the driver determination unit 109 notifies the in-vehicle device control unit 108 that the driver is nearby. When, the in-vehicle device control unit 108 is notified by the driver determination unit 109 that the driver is nearby, the in-vehicle device control unit 108 executes control for permitting the door locking apparatus 112 to lock or unlock the doors. In addition, the in-vehicle device control unit 108 executes control for permitting the engine apparatus 114 to start the engine.

Furthermore, in addition to determining whether the biometric information belongs to the driver, the driver determination unit 109 favorably determines a physical condition of the driver when the biometric information is determined to belong to the driver. The in-vehicle device control unit 108 favorably performs control for providing service depending on the physical condition of the driver. Specifically, the in-vehicle device control unit 108 favorably executes control for prompting the driver to take a rest, notifying the driver of a location of a hospital, or performing an emergency notification.

In addition, when the biometric information is determined not to belong to the driver and the vehicle is driven, the driver determination unit 109 may cause the in-vehicle device control unit 108 to execute a process for tracking the vehicle or execute a process for identifying the position of the vehicle.

Furthermore, when the wireless apparatus having transmitted the biometric information differs from that normally worn by the driver and the vehicle is driven, the driver determination unit 109 may execute a process for tracking the vehicle or execute a process for identifying the position of the vehicle.

### <Operations of Communication System>

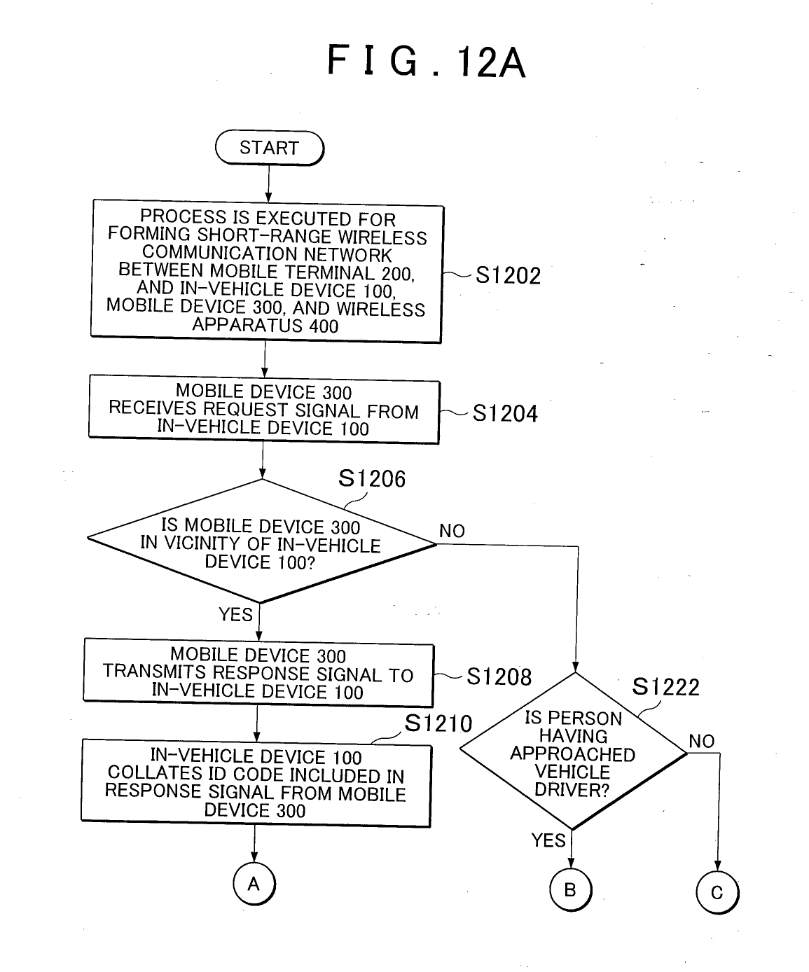

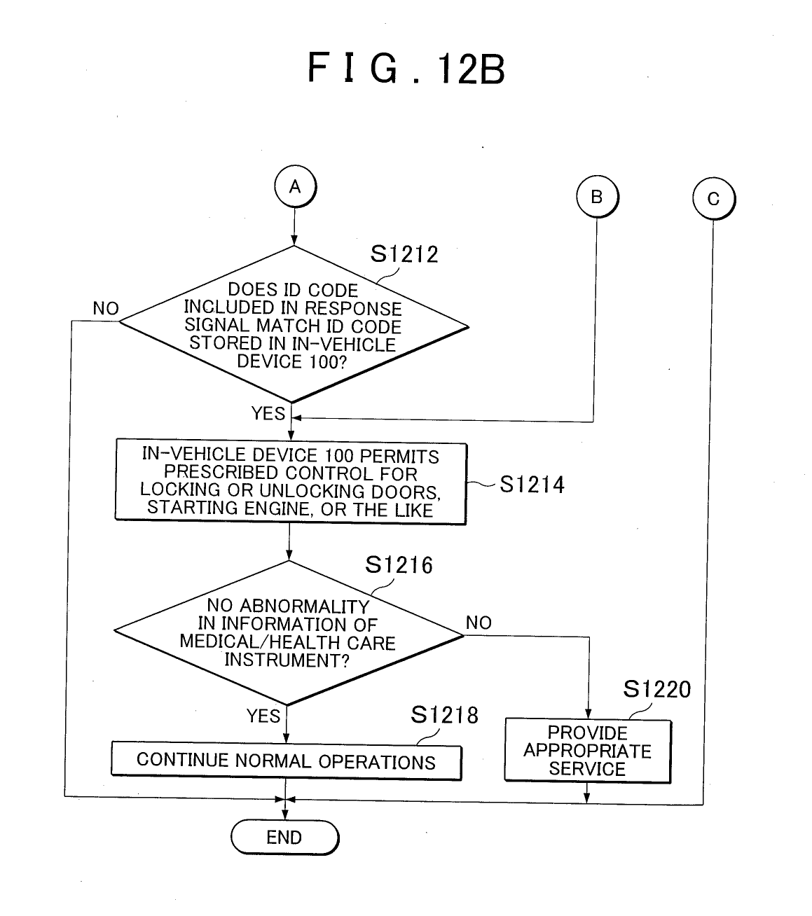

FIGS. 12A and 12B are flow charts showing an example of operations of the communication system.

In step S1202, a process of forming a short-range wireless communication network between the mobile terminal 200, and the in-vehicle device 100, the mobile device 300, and the wireless apparatus 400 is executed. Specifically, the mobile terminal 200 executes a connection process by short-range wireless communication with the in-vehicle device 100. In addition, the mobile terminal 200 executes a connection process by short-range wireless communication with the mobile device 300. Furthermore, the mobile terminal 200 executes a connection process by short-range wireless communication with the wireless apparatus 400.

In step S1204, the mobile device 300 receives a request signal from the in-vehicle device 100.

In step S1206, the mobile device 300 determines whether or not the mobile device 300 is positioned in the vicinity of the in-vehicle device 100. Specifically, the response signal transmission determination unit 309 determines whether or not the mobile device 300 is positioned in the vicinity of the in-vehicle device 100 by determining whether or not a short-range wireless communication network is formed with the mobile terminal 200 and the in-vehicle device 100. When the response signal transmission determination unit 309 determines that a short-range wireless communication network is formed with the mobile terminal 200 and the in-vehicle device 100, the response signal transmission determination unit 309 determines that the mobile device 300 is positioned in the vicinity of the in-vehicle device 100. When the response signal transmission determination unit 309 determines that a short-range wireless communication network is not formed with the mobile terminal 200 and the in-vehicle device 100, the response signal transmission determination unit 309 determines that the mobile device 300 is not positioned in the vicinity of the in-vehicle device 100.

In step S1208, the mobile device 300 transmits a response signal to the in-vehicle device 100 when it is determined in step S1206 that the mobile device 300 is positioned in the vicinity of the in-vehicle device 100. The mobile device control unit 308 generates a response signal to the request signal and performs control for transmitting the response signal from the mobile device transmission unit 304.

In step S1210, the in-vehicle device 100 collates an ID code included in the response signal from the mobile device 300. The response signal from the mobile device 300 is received by the in-vehicle device reception unit 104 of the in-vehicle device 100 and inputted to the in-vehicle device control unit 108. The in-vehicle device control unit 108 collates the ID code included in the response signal with an ID code stored in the memory 110.

In step S1212, the in-vehicle device 100 determines whether or not the ID code included in the response signal matches the ID code stored in the memory 110. The in-vehicle device control unit 108 determines whether or not the ID code included in the response signal matches the ID code stored in the memory 110.

When it is determined in step S1206 that the mobile device 300 is not in the vicinity of the in-vehicle device 100, the in-vehicle device 100 determines whether or not a person having approached the vehicle mounted with the in-vehicle device 100 is the driver. Specifically, the driver determination unit 109 determines whether or not the person is the driver based on the biometric information obtained from the wireless apparatus 400.

In step S1214, the in-vehicle device 100 permits prescribed control for locking or unlocking the doors, starting the engine, or the like when it is determined in step S1212 that the ID codes match or when it is determined in step S1222 that the person having approached the vehicle is the driver. When the in-vehicle device control unit 108 determines that the ID code included in the response signal matches the ID code stored in the memory 110 or when the driver determination unit 109 determines that the person having approached the vehicle is the driver, the in-vehicle device control unit 108 executes control for permitting the door locking apparatus 112 to lock or unlock the doors. In addition, the in-vehicle device control unit 108 executes control for permitting the engine apparatus 114 to start the engine.

When it is determined in step S1212 that the ID code included in the response signal does not match the ID code stored in the in-vehicle device 100 or when it is determined in step S1222 that the person having approached the vehicle is not the driver, the process is terminated.

In step S1216, the mobile terminal 200 determines whether or not there is an abnormality in information of medical or health care instrument. In other words, the mobile terminal 200 determines whether or not there is an abnormality in the biometric information obtained from the wireless apparatus 400.

In step S1218, normal operations are continued when it is determined in step S1216 that there is no abnormality in the information of the medical or health care instrument. In other words, the in-vehicle device 100 continues permission of the prescribed control for locking or unlocking the doors, starting the engine, or the like.

In step S1220, appropriate service is provided when it is determined in step S1216 that there is an abnormality in the information of the medical or health care instrument. Appropriate service is favorably provided by the mobile terminal 200 to the user in accordance with the health care instrument in which the abnormality had been detected. At this point, when it is determined that the information belongs to a person other than the user, a determination that the vehicle has been stolen is favorably made.

According to the modification of the communication system, a short-range wireless communication network is formed among the in-vehicle device 100, the mobile terminal 200, the mobile device 300, and the wireless apparatus 400. For example, when a BAN is applied to the short-range wireless communication network, a communication radius thereof is around 2 m. When a short-range wireless communication network is formed, the mobile device 300 transmits a response signal to the request signal from the in-vehicle device 100. This is because the mobile device 300 is determined to be positioned in the vicinity of the in-vehicle device 100. Therefore, when a signal copied from a request signal from the in-vehicle device 100 is received by the mobile device 300, the mobile device 300 does not transmit a response signal. In this manner, by arranging a response signal to be transmitted when a short-range wireless communication network is formed in the vicinity of the user, the mobile device can be prevented from relaying a passively transmitted response signal. Since a response signal can be prevented from being relayed, theft due to a relayed response signal controlling the vehicle can be prevented. In addition, a highly robust smart key system can be constructed.

Furthermore, even when the mobile device is determined not to be in the vicinity of the vehicle, a determination of whether or not a person is the user of the vehicle can be made based on biometric information obtained from the wireless apparatus in the possession of the user. Therefore, even when a person does not carry a mobile device, locking or unlocking of the doors of the vehicle and starting of the engine of the vehicle can be performed when the person is reliably recognized as the user of the vehicle.

While the invention has been described with reference to a particular example and its modifications, the description of the example and its modifications are purely illustrative and various modifications, corrections, alternatives, substitutions, and the like will be obvious to those skilled in the art. Although apparatuses according to the example of the invention have been described using functional block diagrams for the sake of simplicity, such apparatuses may be realized by hardware, by software, or by a combination thereof. The invention is not limited to the example described above and is intended to cover various modifications, corrections, alternatives, substitutions, and the like without departing from the scope of the invention.

1. A communication system, comprising:
an in-vehicle device including an in-vehicle device short-range wireless communication unit that performs wireless communication using a short-range wireless communication method, and an in-vehicle device control unit that executes control for transmitting a request signal;
a mobile terminal including a mobile terminal short-range wireless communication unit that performs wireless communication using a short-range wireless communication method; and
a mobile device including a mobile device short-range wireless communication unit that performs wireless communication using a short-range wireless communication method, a mobile device control unit that executes control for transmitting a response signal to a request signal from the in-vehicle device, and a mobile device transmission unit that transmits a response signal to the in-vehicle device according to the control by the mobile device control unit, wherein
the in-vehicle device control unit executes control for transmitting the request signal when a short-range wireless communication network is formed with the mobile terminal and the mobile device by the in-vehicle device short-range wireless communication unit.

2. A communication system, comprising:
an in-vehicle device including an in-vehicle device short-range wireless communication unit that performs wireless communication using a short-range wireless communication method, and an in-vehicle device control unit that executes control for transmitting a request signal;
a mobile terminal including a mobile terminal short-range wireless communication unit that performs wireless communication using a short-range wireless communication method; and
a mobile device including a mobile device short-range wireless communication unit that performs wireless communication using a short-range wireless communication method, a mobile device control unit that executes control for transmitting a response signal to a request signal from the in-vehicle device, and a mobile device transmission unit that transmits a response signal to the in-vehicle device according to the control by the mobile device control unit, wherein
the in-vehicle device control unit executes control for transmitting the request signal when a short-range wireless communication network is formed with the mobile terminal by the in-vehicle device short-range wireless communication unit and a short-range wireless communication network is formed between the mobile terminal and the mobile device.

3. The communication system according to claim 1, wherein the mobile device control unit executes control for transmitting a response signal to the request signal from the in-vehicle device when a short-range wireless communication network is formed with the in-vehicle device or the mobile terminal by the mobile device short-range wireless communication unit.

4. The communication system according to claim 1, wherein
the short-range wireless communication network includes a body area network.

5. The communication system according to claim 1, further comprising a wireless apparatus, wherein
the wireless apparatus includes a sensor that detects biometric information, and a wireless apparatus short-range wireless communication unit that notifies the mobile terminal of biometric information detected by the sensor, the mobile terminal short-range wireless communication unit notifying the in-vehicle device of the biometric information obtained from the wireless apparatus, and the in-vehicle device includes a determination unit that determines whether or not a user in possession of the wireless apparatus is a user set in advance based on the biometric information obtained from the wireless apparatus, and a control unit that performs prescribed control when the determination unit determines that the user in possession of the wireless apparatus is the user set in advance.

6. A communication system, comprising:
an in-vehicle device including an in-vehicle device short-range wireless communication unit that performs wireless communication using a short-range wireless communication method, an in-vehicle device positioning apparatus that performs positioning, and an in-vehicle device control unit that executes control for transmitting a request signal;
a mobile terminal including a mobile terminal positioning apparatus that performs positioning, and a mobile terminal control unit that executes control for transmitting a response signal transmission permission signal when a distance between the in-vehicle device and the mobile terminal is less than a prescribed threshold based on an in-vehicle device positioning result by the in-vehicle device positioning apparatus and a mobile terminal positioning result by the mobile terminal positioning apparatus; and
a mobile device including a mobile device control unit that executes control for when a request signal from the in-vehicle device is received making an inquiry to the mobile terminal as to whether or not to transmit a response signal to the request signal when a request signal from the in-vehicle device is received and executes control for transmitting the response signal when the response signal transmission permission signal is received from the mobile terminal.

7. An in-vehicle device in a wireless communication system including the in-vehicle device, a mobile terminal, and a mobile device, the in-vehicle device comprising:
an in-vehicle device short-range wireless communication unit that performs wireless communication using a short-range wireless communication method; and
an in-vehicle device control unit that executes control for transmitting a request signal when a short-range wireless communication network is formed with the mobile terminal and the mobile device by the in-vehicle device short-range wireless communication unit.

8. An in-vehicle device in a wireless communication system including the in-vehicle device, a mobile terminal, and a mobile device, the in-vehicle device comprising:
an in-vehicle device short-range wireless communication unit that performs wireless communication using a short-range wireless communication method; and
an in-vehicle device control unit that executes control for transmitting a request signal when a short-range wireless communication network is formed with the mobile terminal and a short-range wireless communication network is formed between the mobile terminal and the mobile device by the in-vehicle device short-range wireless communication unit.

9. A mobile device in a wireless communication system including an in-vehicle device, a mobile terminal, and the mobile device, the mobile device comprising:
a mobile device short-range wireless communication unit that performs wireless communication using a short-range wireless communication method;
a mobile device control unit that executes control for transmitting a response signal to a request signal from the in-vehicle device when a short-range wireless communication network is formed with the mobile terminal and a short-range wireless communication network is formed between the mobile terminal and the in-vehicle device by the mobile device short-range wireless communication unit; and
a mobile device transmission unit that transmits a response signal to the in-vehicle device according to the control by the mobile device control unit.

10. A mobile device in a wireless communication system including an in-vehicle device, a mobile terminal, and the mobile device, the mobile device comprising:
a mobile device short-range wireless communication unit that performs wireless communication using a short-range wireless communication method;
a mobile device control unit that executes control for transmitting a response signal to a request signal from the in-vehicle device when a short-range wireless communication network is formed with the in-vehicle device and a short-range wireless communication network is formed between the mobile terminal and the in-vehicle device by the mobile device short-range wireless communication unit; and
a mobile device transmission unit that transmits a response signal to the in-vehicle device according to the control by the mobile device control unit.

11. A communication method used by a communication system including an in-vehicle device, a mobile terminal, and a mobile device, comprising:
executing a process of forming a short-range wireless communication network between the in-vehicle device and the mobile terminal and between the in-vehicle device and the mobile device; and
operating the in-vehicle device to execute control for transmitting a request signal when the short-range wireless communication network is formed between the in-vehicle device and the mobile terminal and between the in-vehicle device and the mobile device.

12. A communication method used by a communication system including an in-vehicle device, a mobile terminal, and a mobile device, comprising:
executing a process of forming a short-range wireless communication network between the in-vehicle device and the mobile terminal and between the mobile terminal and the mobile device; and
operating the mobile device to execute control for transmitting a request signal when the short-range wireless communication network is formed between the in-vehicle device and the mobile terminal and between the mobile terminal and the mobile device.

13. A communication system, comprising:
a mobile terminal including a first communication unit that performs wireless communication using a prescribed communication method;
a mobile device including a second communication unit that performs wireless communication using the prescribed communication method, a mobile device reception unit that receives a request signal, a mobile device control unit that controls transmission of a response signal corresponding to the request signal when the mobile device reception unit receives the request signal, and a mobile device transmission unit that transmits a response signal according to the control by the mobile device control unit; and
an in-vehicle device including a third communication unit that performs wireless communication using the prescribed communication method, a memory that stores the formation of a prescribed network by the prescribed communication method as a determination condition, and an in-vehicle device control unit that determines whether the determination condition is met based on information communicated by the third communication unit and that executes control for transmitting the request signal when it is determined that the condition is met.

14. The communication system according to claim 13, wherein
the determination condition is that a network in which wireless communication is performed according to the prescribed communication method is formed between the in-vehicle device and the mobile terminal and between the mobile terminal and the mobile device.

15. The communication system according to claim 13, wherein
the determination condition is that a network in which wireless communication is performed according to the prescribed communication method is formed between the in-vehicle device and the mobile terminal and between the in-vehicle device and the mobile device.

16. The communication system according to claim 2, wherein the mobile device control unit executes control for transmitting a response signal to the request signal from the in-vehicle device when the short-range wireless communication network is formed with the in-vehicle device or the mobile terminal by the mobile device short-range wireless communication unit.

17. The communication system according to claim 2, wherein
the short-range wireless communication network includes a body area network.

18. The communication system according to claim 2, further comprising a wireless apparatus, wherein
the wireless apparatus includes a sensor that detects biometric information, and a wireless apparatus short-range wireless communication unit that notifies the mobile terminal of biometric information detected by the sensor, the mobile terminal short-range wireless communication unit notifying the in-vehicle device of the biometric information obtained from the wireless apparatus, and the in-vehicle device includes a determination unit that determines whether or not a user in possession of the wireless apparatus is a user set in advance based on the biometric information obtained from the wireless apparatus, and a control unit that performs prescribed control when the determination unit determines that the user in possession of the wireless apparatus is the user set in advance.
